(19) United States
(12) Patent Application Publication
(10) Pub. No.: US 2004/0074535 A1
(43) Pub. Date: Apr. 22, 2004

(54) Modular utilities manifold

(75) Inventors: Jotham Wadsworth Coe, Niantic, CT (US); Neil William Campbell, Pawcatuck, CT (US); Thomas Raymond Nardone, Westerly, RI (US)

Correspondence Address: PFIZER INC, 150 EAST 42ND STREET, 5TH FLOOR - STOP 49, NEW YORK, NY, 10017-5612, US

(73) Assignee: Pfizer Inc., New York, NY

(21) Appl. No.: 10/681,290

(22) Filed: Oct. 6, 2003

Related U.S. Application Data
(60) Provisional application No. 60/416,654, filed on Oct. 7, 2002.

(51) Int. Cl. E03B 1/00; F17D 1/00; F25D 21/00

(52) U.S. Cl. 137/271; 62/272

(57) ABSTRACT

A laboratory fume hood utilities manifold for the distribution of a plurality of utilities has an elongated housing frame with the separate intake ports for different respective utilities, such as air, vacuum, nitrogen and water. The manifold includes a plurality of conduits wherein each conduit communicates with a respective intake port. A plurality of outlet ports is connected to each respective conduit. Each outlet port is facing the front of the hood and may selectively be provided with a valve for the controlled supply of the utilities. The manifold also includes a drain outlet port for condenser cooling water disposal, wherein the drain outlet port is disposed below the intake ports, and a drain intake port and downwardly angled drain conduit communicates by gravity flow with the drain outlet port. A downwardly angled steel tube is connected to the drain outlet with the steel tube free end disposed in the fume hood drain.

### FIELD OF THE INVENTION

This invention relates to fluids manifolds. Specifically, this invention relates to a utilities distribution manifold for a fume hood. This invention also specifically relates to a modular utilities manifold for laboratory fume hood use.

### BACKGROUND OF THE INVENTION

Present day pharmaceutical companies, academic laboratories and research centers require chemical and biochemical laboratories that contain multiple and up to several hundred fume hoods. Each fume hood requires its own supply of pressurized utilities or fluids, such as, by way of example, air, nitrogen, water, steam and vacuum. In order to supply such diverse utilities to a large number of fume hoods, an inordinate amount of plumbing is consequentially required. This plumbing in turn necessitates additional building footage and concomitant construction costs. Additionally, conventional fume hood plumbing is costly and difficult to install and maintain. Still further, the diverse chemical and biochemical research operations required diverse fluids at different pressures and flow rates. This further complicates the plumbing scheme. Still further, fume hoods vary in configuration, size and usage, which necessitates tailored utilities distribution arrangements and constructions.

Another problem faced by laboratory fume hood operations is the elimination of cooling water from diverse devices particularly including condensers. The customary technique for the removal of condenser cooling water is to snake a flexible hose from the condenser outlet to the drain in the fume hood work surface. This technique is not entirely satisfactory in that the flexible hose free end is capable of being dislodged from the drain, with consequential loss of effluent control, and water spillage resulting in contamination of ongoing experiments on the fume hood work surface.

The fluid manifold prior art, as exemplified in U.S. Pat. No. 4,712,578, to White; U.S. Pat. No. 4,726,399, to Miller; and U.S. Pat. No. 5,474,102, to Lopez, generally discloses fluid manifold systems which require specialized machined constructions. Such prior art constructions are generally costly to manufacture. These prior art manifolds are generally directed to a single fluid inlet with diverse distribution outlets or to multiple fluid inlets with a single distribution outlet. These prior art manifold constructions are not practical, cost-effective or generally suitable for multiple utilities supply and/or laboratory fume hood use.

The laboratory fume hood art desires a manifold of practical design and construction, and yet safe in operation and efficient, and which provides a plurality of diverse utilities at different pressures or flow rates, and suitable to service diverse fume hood constructions. The laboratory fume hood art also desires ready installation and access to the utilities supply regardless of the utilities supply location. The laboratory fume hood art also desires a practical and efficient means for the removal of condenser cooling water.

The present invention provides a solution to the foregoing laboratory fume hood art needs.

### SUMMARY OF THE INVENTION

A manifold, particularly suitable for and in combination with a laboratory fume hood, has an elongated sheet metal housing frame, with a plurality of fluid inlet or intake ports disposed at one side of the housing frame and a plurality of conduits extending across and disposed within the housing frame. Each conduit communicates with a respective intake port. Several outlet ports are connected to a respective conduit through cut-out portions in the housing frame.

The intake ports are formed for connection to respective stainless steel tubing and/or reinforced flexible hoses for the separate supply of pressurized liquids, gases and/or vacuum. With respect to the supply of water, stainless steel tubing is utilized and connected from the supply to the intake port. This is to ensure an essentially leak proof pressurized water supply system. A selected fluid from diverse fluids, at a selected supply pressure, may be connected to any one of the commonly sized fluid intake ports. The intake ports, outlet ports and conduits are similarly sized to provide for ready interchangeability. Utilities within the contemplation of the invention include, by way of example, air, nitrogen, helium, argon, steam, vacuum, oxygen, hydrogen, glycol, freon and water. Each outlet port may be provided with a pressure or flow control valve, which valve may be mounted in a tee fitting arrangement. A pressure or flow gauge may be connected with and to each pressure or control valve through the tee fitting. The laboratory technician or manifold operator thereby has the ability to provide any particular utility or fluid at desired differential pressures simultaneously through adjacent outlet ports.

Condenser water drain outlet ports are provided at the opposite ends of a downwardly angled drain conduit. Downwardly angled stainless steel tubing is secured to the respective drain outlet ports. The free ends of the steel tubing are disposed in the recessed fume hood drain trough. Drain intake ports are disposed at the front of the manifold. The drain intake ports are connected through cut-outs in the housing frame to tee fittings connected to the drain conduit. The drain conduit is downwardly angled towards the respective drain outlet ports to provide gravity flow from the drain inlet ports through the drain conduit to the drain outlet ports, and in turn through the steel tubing to the drain trough. A hose, such as a flexible polymeric hose, is connected from the outlet of a laboratory condenser to one of the drain intake ports. The condenser cooling water flows through the condenser and condenser outlet and then through the hose to the drain inlet port. The waste condenser cooling water flows downwardly through the drain conduit and respective drain outlet port to the steel tubing and into the drain trough for drain disposal.

The ends of the conduits disposed at the side opposite from the utilities intake ports are formed with respective normally closed fittings for selective attachment, through reinforced flexible hoses or steel tubing, to a like manifold, to provide a modular construction. The modular construction permits multiple connected manifolds for use in elongated or large fume hoods. The modular construction permits either end of the manifold to be connected to the utilities supply, depending on the location of the utilities supply in the fume hood. The modular construction also permits a single utilities supply to service the entire fume hood regardless of the size or length or height of the hood. That is, manifolds may be connected in series horizontally and/or vertically along the entire length and/or height of the fume hood. The modular construction also permits ready manifold removal for repair or replacement with minimal downtime.

### BRIEF DESCRIPTION OF THE DRAWINGS

FIG. 1 is a bottom front prospective partial fragmentary view of the utilities manifold of the present invention mounted in a fume hood;

FIG. 2 is a front elevational view of the manifold;

FIG. 3 is a rear elevational view of the manifold;

FIG. 4 is an enlarged partial fragmentary and schematic view of the intake end of the manifold;

FIG. 5 is an enlarged sectional view taken along line 5-5 of FIG. 1;

FIG. 6 is a front partial fragmentary view of the manifold connected to another manifold in a modular arrangement;

FIG. 7 is a rear elevational view of the manifold in a second embodiment; and

FIG. 8 is an enlarged view taken along line 8-8 of FIG. 7.

### DESCRIPTION OF THE PREFERRED EMBODIMENTS

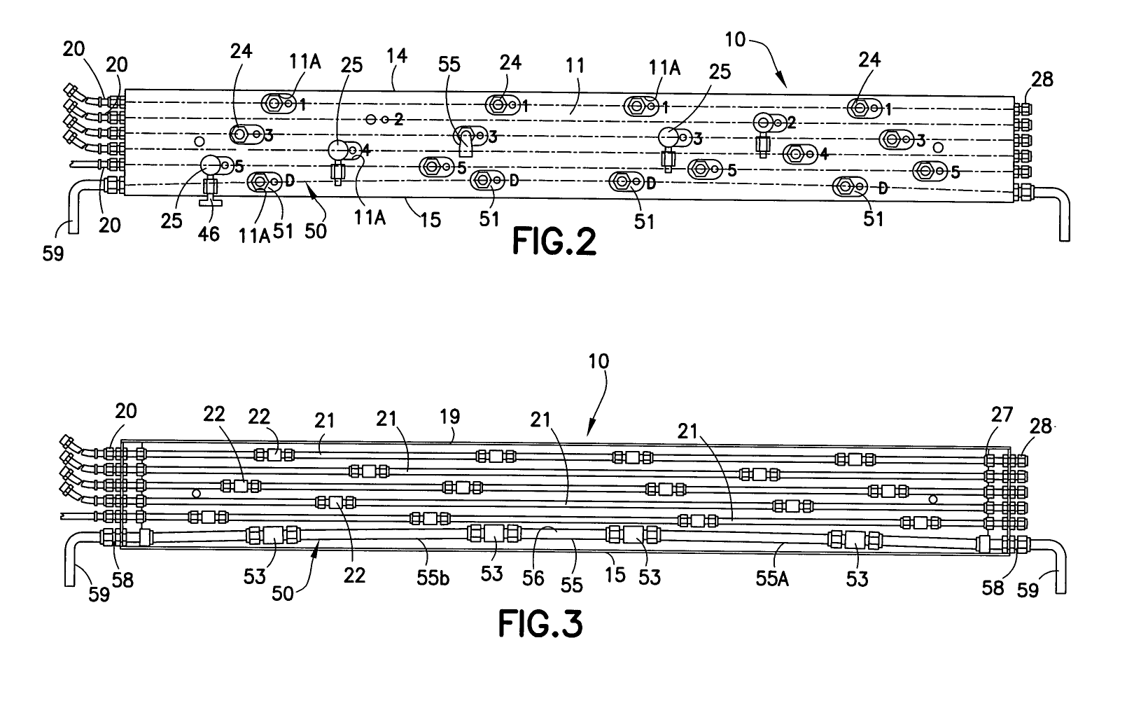

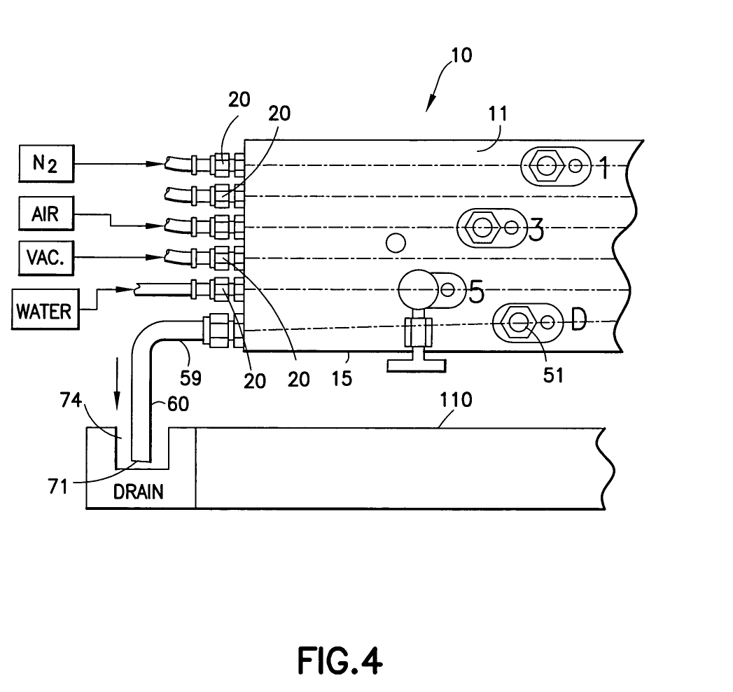

With reference to the Figures, there is shown the manifold 10 of the present invention. Manifold 10 has a stainless steel frame construction, having a front 11, side 12, opposed side 13, top 14 and bottom 15. The manifold front 11 is facingly disposed to the front of a laboratory fume hood 100. Several utility or fluid intake ports 20 (typical) are disposed at cut-out portions 12A (typical) in side 12 and likewise in side 13, for reasons hereinafter appearing. Each intake port 20 and side 12 is connected to a respective stainless steel elongated pipe or conduit 21 (typical). Tee fittings 22 are installed on and spacedly disposed along each respective conduit. Each tee fitting 22 is formed for connection through frame cut-out portion 11A (typical) to an outlet port 24. The outlet port 24 is designed and constructed so as to be readily attachable to a pressure control valve 25 (or alternatively to an e.g. on-off toggle valve 155). Valve 25 and outlet port 24 are disposed forwardly of front 11 so as to be readily accessible for use by the laboratory technician. Valve 25 may be provided in a tee fitting 46, whereby a pressure gauge may be installed in connection with the valve 25 (FIGS. 2 and 4). In this manner of construction, there is a controlled supply of a particular fluid at a desired pressure or flow rate. Pressure or flow control valves 25 may be provided on outlet ports connected to a particular fluid conduit supply, whereby a fluid may be provided at a different pressure or flow rate at each such pressure control valve. This permits the laboratory technician to use, for example nitrogen at one pressure to drive an apparatus, while at another pressure to provide an oxygen free atmosphere or blanket in a particular experiment. It is therefore possible to, by way of specific example, provide nitrogen at one outlet port at 8 psi and at another outlet port at 100 psi, and provide vacuum at 100 mm at one outlet port and at 3 mm at another outlet port.

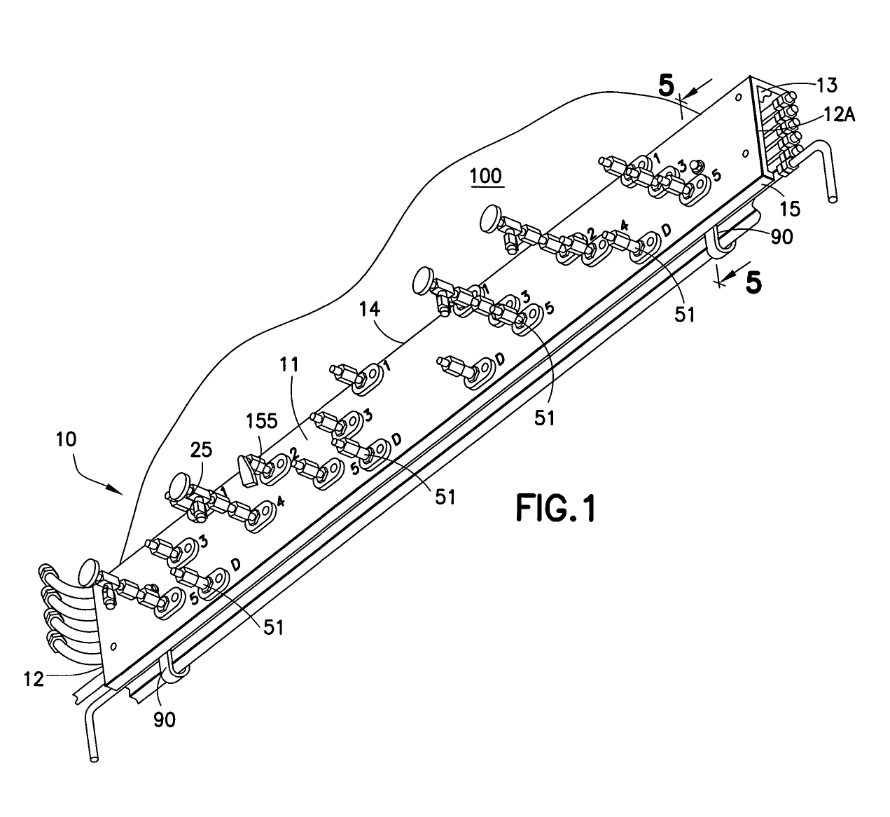

Referring to FIGS. 1-4, each intake port 20 is connected to a flexible polymeric or braided reinforced rubber hose 30 or stainless steel tubing 31, for the supply of a respective utility or fluid. The hose 30 and tubing 31 are connected to respective main utility supply lines (not shown) disposed adjacent to or in the laboratory wall. In this manner of construction, each utility or fluid, such as air, water, vacuum or nitrogen (FIG. 4), at a desired supply pressure, is supplied to a respective intake port, and in turn, to a respective conduit, and then in turn, to a respective valve 25.

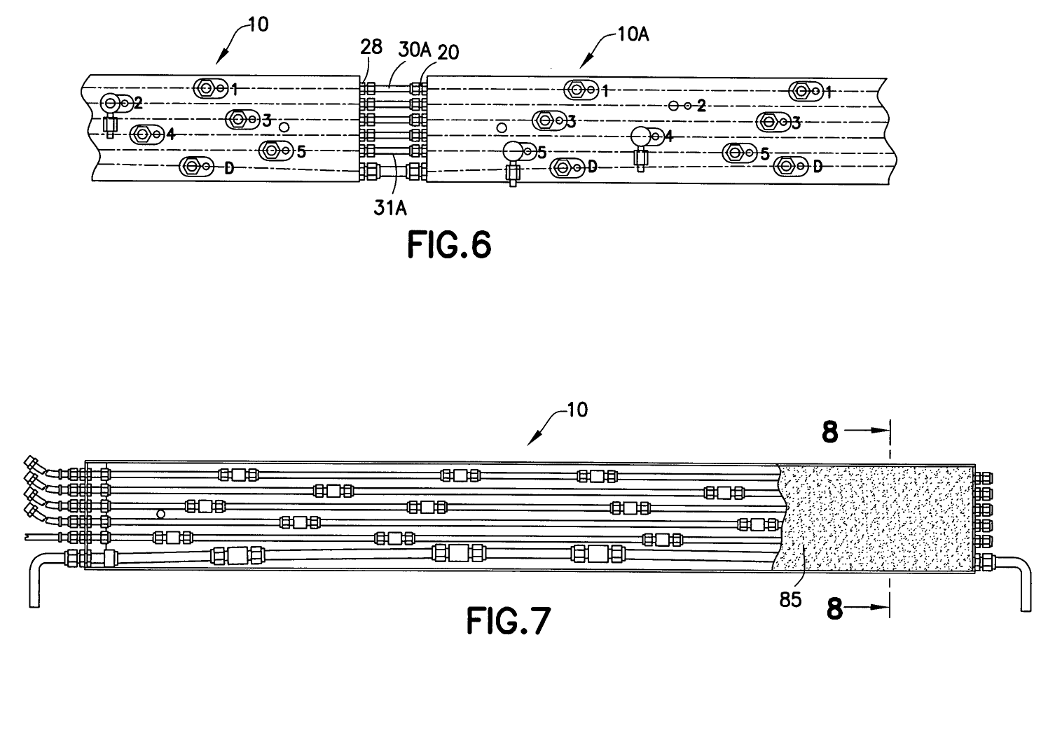

Each conduit 21 is formed, at its remote end 27 at side 13, with a normally closed outlet port or fitting 28 which is readily connectable to a flexible polymeric or braided reinforced rubber hose 30A or stainless steel tubing 31A for connection (e.g. 30A) to the like intake ports of a second like manifold 10A (FIG. 6). In this manner of construction, a modular manifold construction is readily achieved. The present manifold construction provides the ability to use the manifold in diversely sized and configured fume hoods.

The manifold of the present invention, in one embodiment, includes a condenser water drain assembly 50. Assembly 50 includes a plurality of condenser water inlet ports 51 disposed at the front 11 of manifold 10. Each condenser water drain inlet port 51 is connected through housing frame cut-out portions 11A, to a respective tee fitting 53, which is connected to drain conduit 55. Drain conduit 55 is angled downwardly towards respective ends 58 and 59, with the conduit apex 56 disposed at the center of drain conduit 55. Drain conduit 55 has downwardly sloping portions 55b and 55a extending from the apex 56 (FIG. 3). Conduit portion 55a is formed with a drain outlet fitting or port 58. Port 58 is connected to stainless steel outlet pipe or tubing 59. In a like manner, conduit portion 55b is connected to a like port 58 and in turn to like outlet pipe 59. In this manner of construction, condenser cooling water flows downwardly from the condenser outlet through flexible tubing into one of the drain inlet ports 51. The waste cooling water flows through the drain inlet port 51 into one of the downwardly angularly disposed portions 55b or 55a, and in turn, to a respective outlet pipe 59. Each outlet pipe 59 has an angularly downwardly disposed end portion 60 with an open free end 71 disposed in the fume hood drain trough 74 (FIG. 4). The drain pipe 59 free end 71 remains disposed in the drain trough 74 with the manifold 10 mounted in the fume hood 100. This construction and arrangement assures the condenser cooling water drainage without spillage on the laboratory work surface.

It has been found that 1/4 inch stainless steel fittings and 1/4 inch stainless steel conduits are particularly useful in the utilities supply construction. It has also been found that 1/2 inch stainless steel fittings and a 1/2 inch stainless steel conduit are useful in the condenser water drain construction. Such fittings are manufactured by Swagelok. The flexible conduits connected to the intake ports and when desired, connected between modular manifold ports is preferably a Swagelok flame retardant, self-retaining, multi-wall braided rubber hose. The fee fittings, valves and ports are readily commercially available, for example from Swagelok.

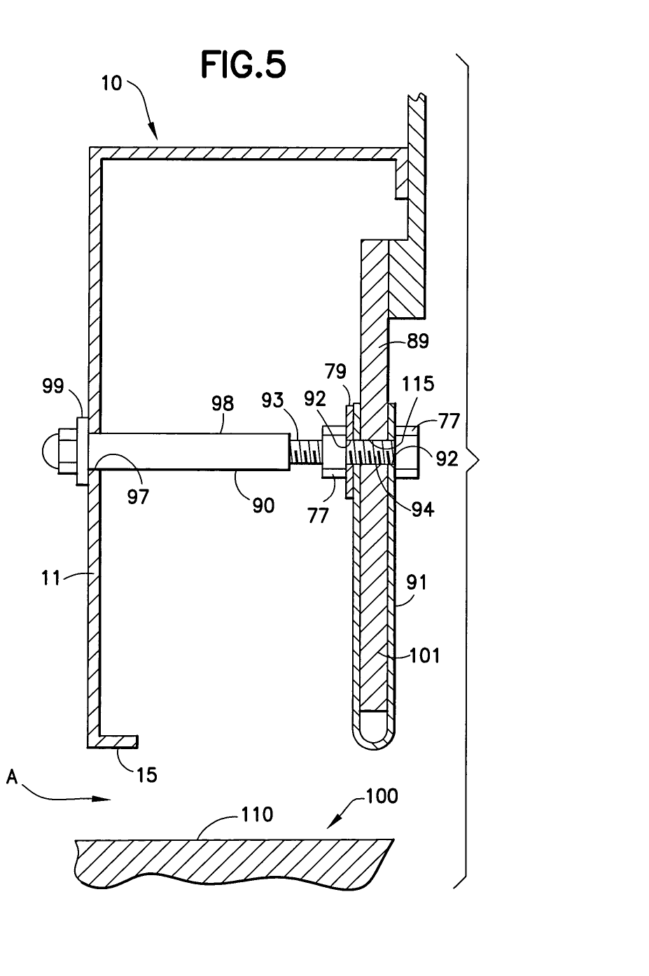

Manifold 10 is mounted in fume hood 100 by connection to the downwardly extending baffle member 89 (FIG. 5). This is accomplished by bracket assembly 90. Bracket assembly 90 includes a steel U-shaped member 91 formed with coaxial holes 92. Pin 93 slidably extends through bracket member holes 92 and baffle member hole 115. A set of retaining nuts 77 and washer 79 are removably connected to the threaded pin end 94. Pin 93 includes sleeve 98 and bearing surface washer 99. The U-shaped member 91 is sized to slidably receive the downwardly disposed end 101 of baffle member 89. Pin 93 extends through hole 97 in housing frame front 11, so that bracket assembly interconnects housing 10 to baffle member 89. Two bracket assemblies 90 are provided and spacedly disposed adjacent respective housing sides 12 and 13 to fully support manifold 10 (FIG. 1). In this manner of bracket assembly and construction, manifold 10 is suspended above fume hood worksurface 110. The fume hood draft air circulates as shown by arrow A, between the bottom 15 of the manifold and the worksurface 110 (FIG. 5). This manifold construction and mounting provides improved access and use of utilities without impeding either the draft air circulation or full utilization of the limited and therefore valuable fume hood worksurface 110.

It is an important aspect of the present invention that in the event of manifold damage or utilities leakage, the hose and tubing connections to the inlet and outlet ports may be readily disconnected and the relatively lightweight frame construction manifold readily manually removed for repair or replacement. With replacement, there is consequently essentially no downtime in fume hood operations and maintenance. This is unlike the prior art constructions where plumbing repairs occasioned extensive fume hood downtime.

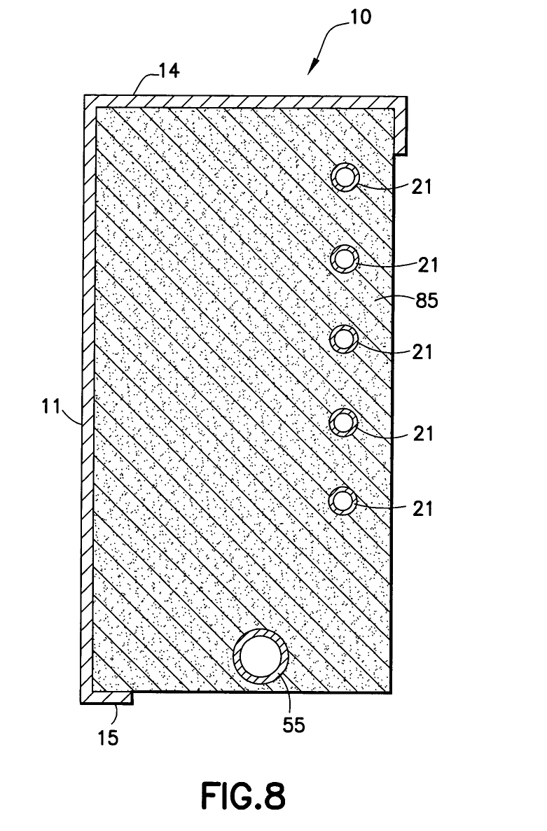

It is also within the contemplation of the present invention, to provide foam insulation within housing 10. FIGS. 7 and 8 shows foam 85, which may be blown or foamed in place in housing 10, by means known in the art. Foam 85 surrounds each stainless steel conduit 21 and the drain conduit 55 so as to insulate one conduit from the other. In this manner of construction, adjacent stainless steel conduits may contain utility fluids of diverse temperatures, such as steam and cooling water, and yet each such respective utility will consequently be supplied at a respective desired constant uniform temperature. The form also protects the conduits from the corrosive gases often attendant fume hood operations.

The present invention also contemplates and provides for the use of specialized gases, such as by way of specific examples, helium, freon, chlorine, hydrogen, argon and the like. A cylinder containing the helium or argon is connected to one of the intake ports by means of the reinforced flexible hose. The valve on the cylinder is turned on and the gas is provided at a predetermined supply pressure. Pressure or flow control valves disposed at the outlet ports permit the laboratory technician to provide the specialized gas at one or more desired pressures for simultaneous use in one or more experiments within the fume hood.

The present invention contemplates a broad range of useful valves including, e.g. pressure and flow control valves and on-off valves of various designs and in any selected desired angular disposition. This diversity of valves and valve dispositions is best shown in FIG. 1. The valve handles may be color-coded for ease of use, to avoid accidents and to prevent unintended use. The connection of a suitable accessory, such as a pressure gauge and/or regulator, to any valve connection port may be routinely performed as desired by a technician or user.

While the foregoing describes only selected embodiments in accordance with the present invention, it is understood that the same are not limited thereto, in that various changes or modifications as known to one of ordinary skill in the art, and it is therefore intended not to be limited to the specific details shown and described, but rather to cover all such modifications, changes, additions, and deletions as are broadly contemplated by the present invention, as set forth in the appended claims.

What is claimed is:

1. A utilities manifold comprising:
a plurality of intake ports, a plurality of conduits, means for connecting each conduit to a respective intake port, pluralities of outlet ports, one plurality of outlet ports communicating with one respective conduit, and means for connecting each outlet port of one said plurality of outlet ports to a respective conduit, whereby a selected utility is provided to an intake port and through the respective conduit and outlet ports.

2. The manifold of claim 1, further comprising an elongated housing frame, said housing frame comprising a front and a side, said outlet ports being disposed at the front and said intake ports being disposed at said side, and said conduits being disposed within said housing frame.

3. The manifold of claim 2, said intake ports being disposed in a first vertically disposed plane, and said outlet ports being disposed in a second vertically disposed plane, each said intake port and respective conduit and respective outlet ports disposed in a respective horizontal plane, said frame being formed with cut-out portions and said outlet ports communicate with said conduits through said cut-out portions.

4. The manifold of claim 3, further comprising a plurality of second outlet ports, said second outlet ports being disposed in a third vertically disposed plane, and means for connecting each respective second outlet port delete with a respective conduit and with one plurality of said first outlet ports, whereby each said second outlet port is connectable to a respective intake port of a second manifold to provide a modular construction.

5. The manifold of claim 1, said means for connecting said outlet ports comprising tee connections, each tee connection communicating with one said outlet port and one respective conduit.

6. The manifold of claim 1, said intake ports being formed for disconnectable connection to supply hoses or tubing.

7. The manifold of claim 1, further comprising a drain outlet port for condenser cooling water disposal.

8. The manifold of claim 7, further comprising a drain conduit communicating with said drain outlet port, and at least one said drain intake port communicating with said drain conduit.

9. The manifold of claim 8, said drain conduit being disposed so as to provide gravity flow from the drain intake port to the drain outlet port, said drain intake port being formed for connection to a condenser water discharge hose.

10. The manifold of claim 1, further comprising a plurality of valves, each said valve being connected to a respective outlet port for one said conduit, for the simultaneous controlled supply of a fluid at different pressures.

11. In combination:
a fume hood; and
a utilities manifold disposed within said fume hood, said manifold comprising, a plurality of first intake ports, a plurality of conduits, means for connecting each conduit with a respective intake port, pluralities of first outlet ports, one plurality of fluid outlet ports communicating with one respective conduit and respective intake port, and means for connecting each said outlet port to a respective conduit, whereby a selected utility is provided to a first intake port, and through the respective conduit and outlet ports for fume hood use.

12. The combination of claim 11, further comprising a drain outlet port for condenser cooling water disposal.

13. The combination of claim 12, further comprising a drain conduit, said drain conduit communicating with said drain outlet port, and at least one drain intake port and means for connecting said drain intake to said drain conduit.

14. The combination of claim 13, said drain conduit being angularly disposed so as to provide gravity flow from the drain intake port to the drain outlet port.

15. The combination of claim 14, further comprising an elongated housing frame, said housing frame having a front and a side, said first outlet ports and said drain intake port being disposed at the front, said first intake ports and said drain outlet port being disposed at said side, and said conduits being disposed within said housing frame.

16. The combination of claim 11, said frame comprising sheet construction formed with cut-out portions, and the ports communicating with the conduits through the cutout portions.

17. The combination of claim 11, further comprising a plurality of valves, each said valve being connected to a respective first outlet port, for controlled supply of a specific fluid or vacuum.

18. The combination of claim 11, said manifold further comprising a housing, said conduits being disposed within said housing and said ports being disposed outside said housing.

19. The combination of claim 18, further comprising a plurality of flexible conduits, and means for connecting each said flexible conduit to a respective first intake port, said flexible conduits extending from the intake ports to outside of said fume hood to respective fluid supply means.

20. The combination of claim 18, further comprising a plurality of valves, each said valve being connected to a respective first outlet port, said valves being disposed outside said hood and facingly disposed to the front of the hood.

21. The combination of claim 11, further comprising bracket means for mounting said housing within said hood.

22. The combination of claim 19, further comprising means for disconnectably connecting the flexible conduits to said first intake ports, whereby the manifold is readily removably replaceable from within the hood.

23. The combination of claim 11, said first intake ports comprising commonly sized fittings, and said conduits been similarly sized to the intake ports, and means for supplying a fluid or vacuum to each respective first intake port.

24. The combination of claim 11, said fluid intake ports being in vertical alignment, and said outlet ports connected to their respective conduit being in horizontal alignment, and said conduits being spacedly disposed.

25. The combination of claim 11, further comprising an elongated housing comprising a frame, said conduits being disposed within said housing frame and said ports being disposed outside said housing frame, said housing comprising a front and a side, said first intake ports being disposed adjacent said side and said fluid outlet ports being disposed adjacent said front.

26. The combination of claim 25, further comprising a plurality of valves, and means for connecting each valve to a respective first outlet port, whereby the user accesses each of the valves for controlled supply of a fluid or vacuum.

27. The combination of claim 11, further comprising a plurality of second outlet ports, said second outlet ports being disposed in a third vertically disposed plane, each respective second outlet port communicating with a respective conduit and first outlet port, whereby each second outlet port is connectable to a respective fluid intake port of a second manifold to provide a modular construction.

28. The combination of claim 27, said manifold further comprising a housing comprising a frame, said conduits being disposed within said housing frame and said ports being disposed outside said housing frame.

29. The combination of claim 28, said housing frame comprising sheet construction comprising a front and oppositely disposed sides, and the said frame sheet construction being formed with cut-out portions that provide for the ports to connect with the conduits, with the ports extending outside the frame sheet.

30. The combination of claim 11, said fume hood comprising a work surface, and further comprising bracket means for mounting said manifold in said hood so that said manifold is disposed above the fume hood work surface.

31. The combination of claim 30, said bracket means further comprising means for suspending the manifold above the work surface, whereby the fume hood draft air circulates between the manifold and the work surface.

32. The combination of claim 31, said fume hood comprising a baffle member, and said bracket means for connecting the baffle member to the manifold.

33. The combination of claim 32, said manifold comprising a bottom, and wherein the fume hood draft air circulates between the manifold bottom and the fume hood work surface.

34. The combination of claim 33, said bracket means comprising a U-shaped member, and wherein the baffle member is slidably disposed in the U-shaped member.

35. The combination of claim 34, said bracket means further comprising a pin and means for connecting the pin to the baffle member, U-shaped member and manifold.
